(19) United States
(12) Patent Application Publication
(10) Pub. No.: US 2020/0355203 A1
(43) Pub. Date: Nov. 12, 2020

(54) AIR CYLINDER FLUID CIRCUIT AND METHOD FOR DESIGNING SAME

(71) Applicant: SMC CORPORATION, Chiyoda-ku (JP)

(72) Inventors: Yoshiyuki TAKADA, Ichikawa-shi (JP); Tsuyoshi ASABA, Abiko-shi (JP); Akihiro KAZAMA, Moriya-shi (JP); Mitsuru SENOO, Moriya-shi (JP); Gohei HARIMOTO, Moriya-shi (JP)

(73) Assignee: SMC CORPORATION, Chiyoda-ku (JP)

(21) Appl. No.: 16/640,499

(22) PCT Filed: Mar. 14, 2018
(86) PCT No.: PCT/JP2018/009844

§ 371 Date: Feb. 20, 2020

(30) Foreign Application Priority Data
Aug. 30, 2017 (JP) 2017-165113
Oct. 11, 2017 (JP) 2017-197673

(51) Int. Cl. F15B 13/04; F15B 11/064; F15B 21/00; F15B 11/04

(52) U.S. Cl. CPC F15B 13/0401; F15B 11/064; F15B 2211/40515; F15B 11/04; F15B 2211/30525; F15B 21/008

(57) ABSTRACT

An air cylinder fluid circuit is formed by connecting a switching valve, which switches the supply and discharge of compressed air, and cylinder port parts of an air cylinder by means of pipes, wherein the acoustic velocity conductance of the pipes is smaller than the acoustic velocity conductance of the switching valve and the cylinder port parts.

### TECHNICAL FIELD

The present invention relates to fluid circuits for supplying and discharging fluid to and from air cylinders and methods for designing the same.

### BACKGROUND ART

Providing a fluid circuit of an air cylinder with a speed controller (variable orifice mechanism) is a known technique for adjusting the flow rate of compressed air supplied to or discharged from the air cylinder to adjust the moving speed of the piston.

For example, a fluid-pressure system described in Japanese Laid-Open Patent Publication No. 2011-012746 is provided with speed controllers, capable of adjusting the flow rate of pressurized fluid supplied to fluid-pressure cylinders, in tubes connecting drive switching valves to ports of the fluid-pressure cylinders.

A typical tube constituting a fluid circuit of an air cylinder has a large effective area and a low airflow resistance to speed up the piston and thus to reduce the response time of the cylinder.

A tube described in Japanese Laid-Open Patent Publication No. 2017-089820 is provided with a volume reduction portion and connects a cylinder to a speed controller disposed at a position away from the cylinder. According to the description, the moving speed of the piston can be precisely adjusted even when the tube becomes longer.

### SUMMARY OF INVENTION

Since a typical tube constituting a fluid circuit of an air cylinder has a large effective area as described above, compressed air remaining inside the tube without reaching the inside of the air cylinder is released to the atmosphere when a switching valve switches to a discharge position. That is, a considerable amount of compressed air is discarded without directly contributing toward moving the air cylinder, leading to more consumption of compressed air. In addition, a fixed orifice serving as the reference resistance of the fluid circuit is also required to be provided for a port or the like of the air cylinder assuming that no speed controller is provided. Although the volume of the tube described in Japanese Laid-Open Patent Publication No. 2017-089820 is reduced, this is not intended to reduce consumption of compressed air.

The present invention has been devised to design a fluid circuit such that the reference resistance of the fluid circuit is approximately determined by a tube, and has the object of reducing consumption of compressed air as well as simplifying the fluid circuit by, for example, negating the need for a fixed orifice.

An air cylinder fluid circuit according to the present invention comprises a switching valve configured to switch between supply and discharge of compressed air, an air cylinder, and a tube connecting the switching valve and a cylinder port portion of the air cylinder, wherein a sonic conductance of the tube is less than sonic conductances of the switching valve and the cylinder port portion.

According to the above-described air cylinder fluid circuit, the resistance of the entire circuit is affected by the tube the most. Thus, no fixed orifice is required for the air cylinder (no small hole is required to be bored in the air cylinder). In addition, consumption of compressed air can be reduced.

In the above-described air cylinder fluid circuit, the sonic conductance of the tube is preferably less than or equal to half the sonic conductances of the switching valve and the cylinder port portion. According to this, the resistance of the entire circuit is determined by the tube. Thus, no fixed orifice is required for the air cylinder. In addition, the operating speed of the air cylinder can be set based on the tube.

In a case where a speed controller is disposed between the tube and the cylinder port portion, the sonic conductance of the tube is required to be less than a sonic conductance of the speed controller. In this case, the sonic conductance of the tube is preferably less than or equal to half the sonic conductances of the switching valve, the cylinder port portion, and the speed controller. According to this, the resistance of the entire circuit is also predominantly affected by the tube in the case where the speed controller is disposed between the tube and the cylinder port portion. In particular, when the sonic conductance of the tube is substantially half the sonic conductance of the speed controller, the operating speed can be adjusted in a range from the operating speed serving as the maximum operating speed to a speed lower than the operating speed by a predetermined amount with an excellent sensitivity.

Furthermore, in a case where a silencer is provided to an exhaust port of the switching valve, the sonic conductance of the tube is required to be less than a sonic conductance of the silencer. In this case, the sonic conductance of the tube is preferably less than or equal to half the sonic conductances of the switching valve, the cylinder port portion, and the silencer. According to this, the resistance of the entire circuit is also predominantly affected by the tube in the case where the silencer is provided to the exhaust port of the switching valve.

A method for designing an air cylinder fluid circuit according to the present invention is a method for designing an air cylinder fluid circuit including a switching valve configured to switch between supply and discharge of compressed air, an air cylinder, and a tube connecting the switching valve and a cylinder port portion of the air cylinder. The method for designing the air cylinder fluid circuit comprises selecting a predetermined air cylinder, a predetermined tube, and a predetermined switching valve from a database of air cylinders, a database of tubes, and a database of switching valves, respectively, to design the air cylinder fluid circuit such that a sonic conductance of the tube is less than sonic conductances of the switching valve and the cylinder port portion. In a case where the air cylinder fluid circuit is provided with a speed controller or a silencer, the method for designing the air cylinder fluid circuit further comprises selecting a predetermined speed controller or a predetermined silencer from a database of speed controllers or a database of silencers, respectively, to design the air cylinder fluid circuit such that the sonic conductance of the tube is less than a sonic conductance of the speed controller or the silencer. By designing in this manner, the reference resistance of the fluid circuit can be approximately determined by the tube.

In accordance with the air cylinder fluid circuit according to the present invention, the resistance of the entire circuit is predominantly affected by the tube. Thus, no fixed orifice is required for the air cylinder, and the fluid circuit can be simplified. In addition, consumption of compressed air can be reduced.

The above-described object, features, and advantages will become more apparent from the following description of preferred embodiments in conjunction with the accompanying drawings.

### BRIEF DESCRIPTION OF DRAWINGS

FIG. 1 is a schematic view of an air cylinder fluid circuit according to an embodiment of the present invention;

FIG. 2A is an enlarged view of part A of the air cylinder fluid circuit in FIG. 1, and FIG. 2B is an enlarged view of part B of the air cylinder fluid circuit in FIG. 1;

FIG. 3 is a graph illustrating a relationship between the sonic conductance and length of a tube for different inner diameters of the tube;

FIG. 4 is part of a flow chart according to a method for designing the air cylinder fluid circuit in FIG. 1; and

FIG. 5 is the rest of the flow chart according to the method for designing the air cylinder fluid circuit in FIG. 1.

### DESCRIPTION OF EMBODIMENTS

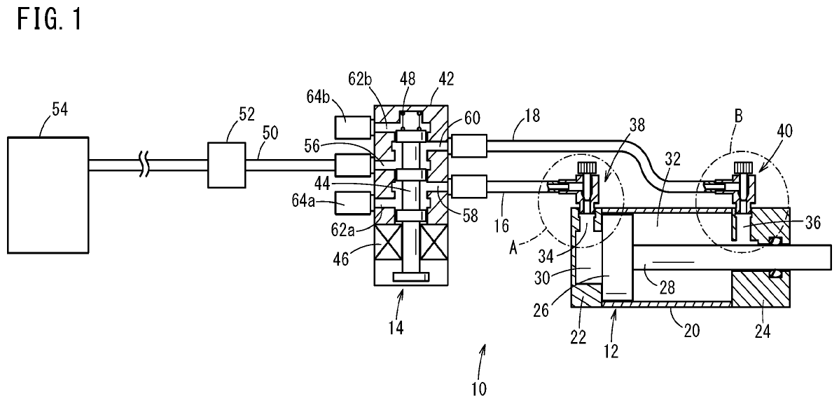

A preferred embodiment of an air cylinder fluid circuit according to the present invention will be described in detail below with reference to the accompanying drawings. In FIG. 1, reference numeral 10 denotes an air cylinder fluid circuit according to the embodiment of the present invention.

The air cylinder fluid circuit 10 includes a double-acting air cylinder 12 and a switching valve 14 connected to each other by a first tube 16 and a second tube 18.

The air cylinder 12 includes a cylinder tube 20, an end cover 22, a rod cover 24, a piston 26, and a piston rod 28. The end cover 22 is secured to one end of the cylindrical cylinder tube 20 in the axial direction, and the rod cover 24 is secured to another end of the cylinder tube 20 in the axial direction. The piston 26 is disposed inside the cylinder tube 20 to be slidable and is linked to one end of the piston rod 28. Another end of the piston rod 28 passes through the rod cover 24 and extends to the outside. The space inside the cylinder tube 20 is partitioned into a first cylinder chamber 30 adjacent to the end cover 22 and a second cylinder chamber 32 adjacent to the rod cover 24.

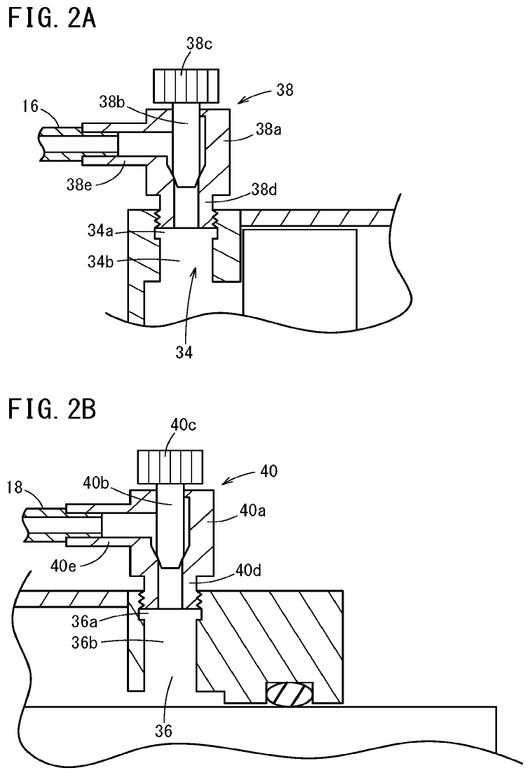

The end cover 22 is provided with a first cylinder port portion 34 for supplying and discharging compressed air to and from the first cylinder chamber 30. As illustrated in FIG. 2A, the first cylinder port portion 34 includes an opening part 34a opened in the side face of the end cover 22 and a hole part 34b adjoining the opening part 34a. The rod cover 24 is provided with a second cylinder port portion 36 for supplying and discharging compressed air to and from the second cylinder chamber 32. As illustrated in FIG. 2B, the second cylinder port portion 36 includes an opening part 36a opened in the side face of the rod cover 24 and a hole part 36b adjoining the opening part 36a.

A first speed controller 38 is attached to the opening part 34a of the first cylinder port portion 34, and a second speed controller 40 is attached to the opening part 36a of the second cylinder port portion 36. The first speed controller 38 allows manual adjustment of the flow rate of compressed air discharged from the first cylinder chamber 30, and the second speed controller 40 allows manual adjustment of the flow rate of compressed air discharged from the second cylinder chamber 32. That is, the first speed controller 38 and the second speed controller 40 are of the meter-out type. However, the speed controllers may be of the meter-in type allowing adjustment of the flow rate of compressed air supplied to the cylinder chambers.

As illustrated in FIG. 2A, the first speed controller 38 is provided with a tube fitting 38a and a needle valve 38b disposed inside the tube fitting 38a. The flow rate of compressed air flowing inside the tube fitting 38a in a predetermined direction can be adjusted by manually operating a knob 38c linked to the needle valve 38b. The tube fitting 38a includes a port connection part 38d connected to the first cylinder port portion 34 of the air cylinder 12 and a tube connection part 38e connected to the first tube 16.

As illustrated in FIG. 2B, the second speed controller 40 is provided with a tube fitting 40a and a needle valve 40b disposed inside the tube fitting 40a. The flow rate of compressed air flowing inside the tube fitting 40a in a predetermined direction can be adjusted by manually operating a knob 40c linked to the needle valve 40b. The tube fitting 40a includes a port connection part 40d connected to the second cylinder port portion 36 of the air cylinder 12 and a tube connection part 40e connected to the second tube 18.

The switching valve 14 includes, for example, a valve housing 42, a spool 44, an electromagnetic coil 46, and a spring 48. The valve housing 42 has a supply port 56 connected to a compressor 54 via a supply tube 50 and a pressure regulator 52, a first output port 58 connected to the first tube 16, a second output port 60 connected to the second tube 18, and two exhaust ports 62a and 62b connected to the atmosphere. The spool 44 is disposed inside the valve housing 42 to be slidable. The exhaust ports 62a and 62b are respectively provided with silencers 64a and 64b.

While the electromagnetic coil 46 is not energized, the spool 44 is held in a first position by the biasing force of the spring 48. When the electromagnetic coil 46 is energized, the spool 44 moves to a second position against the biasing force of the spring 48. When the spool 44 is in the first position, the first output port 58 is connected to the exhaust port 62a, and the second output port 60 is connected to the supply port 56 (see FIG. 1). When the spool 44 is in the second position, the first output port 58 is connected to the supply port 56, and the second output port 60 is connected to the exhaust port 62b.

The air cylinder fluid circuit 10 is designed such that the resistance of the entire circuit is affected by the first tube 16 and the second tube 18 the most. That is, the sonic conductances of the first tube 16 and the second tube 18 are designed to be less than the sonic conductances of the switching valve 14, the first cylinder port portion 34, the second cylinder port portion 36, the first speed controller 38, the second speed controller 40, and the silencers 64a and 64b. In particular, in a case where the sonic conductances of the first tube 16 and the second tube 18 are less than or equal to half the sonic conductances of the above-described circuit elements, the resistance of the entire circuit is determined by the first tube 16 and the second tube 18 and is not affected by the above-described circuit elements.

Here, sonic conductance is a predetermined coefficient in flow rate expressions defined by ISO and adopted by JIS (JIS B 8390-2000) in 2000, and is an index indicating how easily the air can flow as is effective area or CV value. The unit of sonic conductance is dm³/(s·bar). A lower sonic conductance means a higher resistance to air flow.

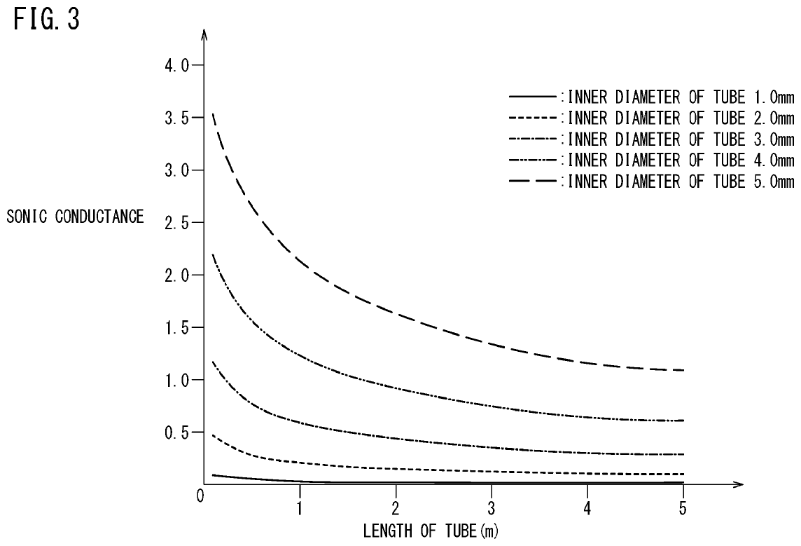

Next, the sonic conductance of a tube will be described. FIG. 3 indicates a relationship between the sonic conductance of a tube and the length of the tube for different inner diameters of the tube. Specifically, the figure illustrates the sonic conductance obtained when the length of the tube is changed from 0.1 to 5.0 m for cases where the inner diameters of the tube are 5.0 mm, 4.0 mm, 3.0 mm, 2.0 mm, and 1.0 mm. As illustrated in FIG. 3, the sonic conductance decreases as the length of the tube increases and as the inner diameter of the tube decreases. For example, when the length of the tube is 2 m, the sonic conductance takes values of 1.63, 0.92, 0.44, 0.15, and 0.02 for the above-described inner diameters of the tube.

The sonic conductances of the circuit elements in the air cylinder fluid circuit 10 including the first tube 16 and the second tube 18 are designed, for example, as follows.

The inner diameters of the first tube 16 and the second tube 18 are set to 3.0 mm, and the lengths of the tubes are set to 2.0 m. With this condition, the sonic conductances of the first tube 16 and the second tube 18 become 0.44. The lengths of the first tube 16 and the second tube 18 are basically determined according to the environment where the air cylinder 12 and the switching valve 14 are installed (distance between the air cylinder 12 and the switching valve 14).

The inner diameters of the hole parts 34b and 36b of the first cylinder port portion 34 and the second cylinder port portion 36, respectively, are set to 10.9 mm. With this condition, the sonic conductances of the first cylinder port portion 34 and the second cylinder port portion 36 become 16.8. Note that the inner diameters of the hole parts 34b and 36b of the first cylinder port portion 34 and second cylinder port portion 36, respectively, have been typically designed to be about 2 mm so that the hole parts function as fixed orifices.

The sonic conductance of the adopted switching valve 14 is 1.92, and the sonic conductances of the adopted silencers 64a and 64b are 2.0. The sonic conductances of the adopted first speed controller 38 and the adopted second speed controller 40 are both 0.88.

According to the above-described design example, the sonic conductances of the first tube 16 and the second tube 18 are less than or equal to half the sonic conductances of the switching valve 14, the first cylinder port portion 34, the second cylinder port portion 36, the first speed controller 38, the second speed controller 40, and the silencers 64a and 64b. Thus, the resistance of the entire air cylinder fluid circuit 10 is determined by the first tube 16 and the second tube 18. In addition, the sonic conductances of the first tube 16 and the second tube 18 are exactly half the sonic conductances of the first speed controller 38 and the second speed controller 40.

The air cylinder fluid circuit 10 according to the embodiment of the present invention and the specific design example have been described above. Next, the operations and operational effects thereof will be described.

When the switching valve 14 is in the first position, compressed air supplied from the compressor 54 via the pressure regulator 52 is supplied into the second tube 18 through the supply port 56 and the second output port 60 of the switching valve 14. The compressed air supplied into the second tube 18 is supplied to the second cylinder chamber 32 via the second speed controller 40 and the second cylinder port portion 36. In addition, compressed air inside the first cylinder chamber 30 is discharged into the first tube 16 through the first cylinder port portion 34 after the flow rate is adjusted by the first speed controller 38. The compressed air discharged into the first tube 16 is released to the atmosphere through the first output port 58 and the exhaust port 62a of the switching valve 14 and then through the silencer 64a. This causes the piston 26 to be driven toward the end cover 22 and thus causes the piston rod 28 to be retracted.

When the electromagnetic coil 46 is energized and the switching valve 14 is thereby in the second position, compressed air supplied from the compressor 54 via the pressure regulator 52 is supplied into the first tube 16 through the supply port 56 and the first output port 58 of the switching valve 14. The compressed air supplied into the first tube 16 is supplied to the first cylinder chamber 30 via the first speed controller 38 and the first cylinder port portion 34. In addition, compressed air inside the second cylinder chamber 32 is discharged into the second tube 18 through the second cylinder port portion 36 after the flow rate is adjusted by the second speed controller 40. The compressed air discharged into the second tube 18 is released to the atmosphere through the second output port 60 and the exhaust port 62b of the switching valve 14 and then through the silencer 64b. This causes the piston 26 to be driven toward the rod cover 24 and thus causes the piston rod 28 to be pushed out.

Next, the amount of compressed air consumed by discharging compressed air remaining inside the first tube 16 and the second tube 18 from the exhaust ports 62a and 62b of the switching valve 14 will be described. When the consumption of compressed air for the first tube 16 and the second tube 18 having the inner diameters of 5.0 mm is defined as 100, the consumptions of compressed air for the first tube 16 and the second tube 18 having the inner diameters of 4.0 mm, 3.0 mm, 2.0 mm, and 1.0 mm are 64, 36, 16, and 4, respectively. That is, the consumption of compressed air decreases by reducing the inner diameters of the first tube 16 and the second tube 18.

Although the maximum operating speed of the air cylinder 12 (maximum drive speed of the piston 26) depends also on the inner diameter of the cylinder tube 20 and the like, the maximum operating speed takes a value according to the sonic conductances of the first tube 16 and the second tube 18 in the above-described design example. The operating speed of the air cylinder 12 can be adjusted in a range from the maximum operating speed to a speed lower than the maximum operating speed by a predetermined amount by making full use of the first speed controller 38 and the second speed controller 40. In the above-described design example, the sonic conductances of the first tube 16 and the second tube 18 are set to half the sonic conductances of the first speed controller 38 and the second speed controller 40. Thus, the operating speed of the air cylinder 12 can be adjusted effectively in the entire operating range of the knobs 38c and 40c.

According to the air cylinder fluid circuit 10 of this embodiment, in particular, according to the above-described design example, the resistance of the entire air cylinder fluid circuit 10 is determined by the first tube 16 and the second tube 18. Thus, no fixed orifice is required for the air cylinder 12. In addition, since the inner diameters of the first tube 16 and the second tube 18 are small, consumption of compressed air can be reduced. Furthermore, the maximum operating speed of the air cylinder 12 can be determined based on the first tube 16 and the second tube 18.

In the air cylinder fluid circuit 10 of this embodiment, the first speed controller 38 and the second speed controller 40 are respectively attached to the first cylinder port portion 34 and the second cylinder port portion 36. However, the first speed controller 38 and the second speed controller 40 are not necessarily attached. That is, the first tube 16 and the second tube 18 may be directly connected to the first cylinder port portion 34 and the second cylinder port portion 36, respectively. In addition, the exhaust ports 62a and 62b of the switching valve 14 are respectively provided with the silencers 64a and 64b. However, the silencers 64a and 64b are not necessarily provided.

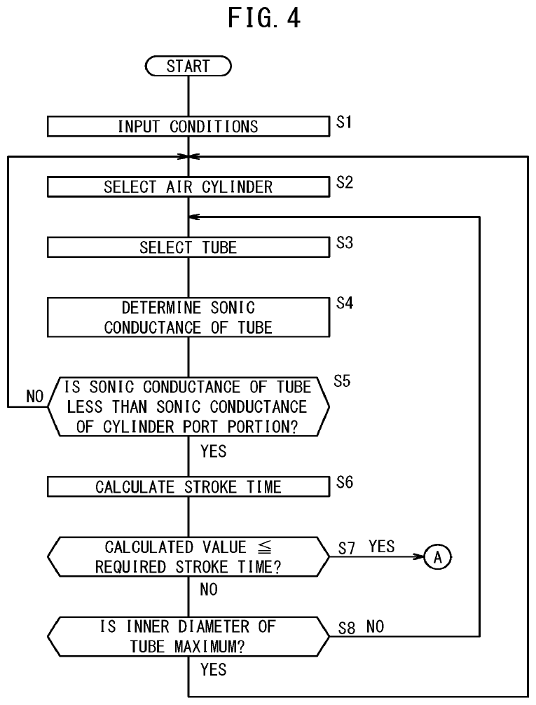

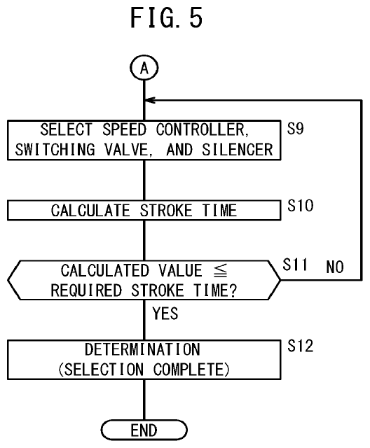

Next, a preferred embodiment of a method for designing the air cylinder fluid circuit 10 according to the present invention will be described below with reference to FIGS. 4 and 5.

Databases required to design the air cylinder 12, the first tube 16, the second tube 18, the first speed controller 38, the second speed controller 40, and the silencers 64a and 64b in the air cylinder fluid circuit 10 are created in advance. That is, a database of air cylinders, a database of tubes, a database of speed controllers, a database of switching valves, and a database of silencers are created.

The database of air cylinders contains multiple pieces of air cylinder data. Each piece of air cylinder data includes the inner diameter of a cylinder tube (cylinder bore) and the sonic conductance of a cylinder port portion. The database of tubes contains multiple pieces of tube data. Each piece of tube data includes the inner diameter of the corresponding tube. The database of speed controllers contains multiple pieces of speed controller data. Each piece of speed controller data includes the sonic conductance of the corresponding speed controller. The database of switching valves contains multiple pieces of switching valve data. Each piece of switching valve data includes the sonic conductance of the corresponding switching valve. The database of silencers contains multiple pieces of silencer data. Each piece of silencer data includes the sonic conductance of the corresponding silencer.

In S1, conditions such as the amount of stroke of the air cylinder 12, the required stroke time of the air cylinder 12, the pressure of air supplied to the air cylinder 12, the load to the air cylinder 12, the length of the first tube 16, and the length of the second tube 18 are input.

In S2, one air cylinder is selected from the database of air cylinders based on the conditions such as the amount of stroke of the air cylinder 12, the pressure of air supplied to the air cylinder 12, and the load to the air cylinder 12.

In S3, a tube having the minimum inner diameter is selected from the database of tubes. In S4, the sonic conductances of the first tube 16 and the second tube 18 are determined also in consideration of the length of the first tube 16 and the length of the second tube 18.

In S5, it is determined whether the sonic conductances of the first tube 16 and the second tube 18 determined in S4 are less than the sonic conductances of the cylinder port portions of the air cylinder selected in S2. If it is determined that the sonic conductances of the first tube 16 and the second tube 18 are less than the sonic conductances of the cylinder port portions, the process moves to S6. Otherwise, the process returns to S2, and an air cylinder is selected again, excluding the air cylinders that have already been selected.

In S6, the stroke time of the air cylinder is calculated by simulation based on the sonic conductances of the first tube 16 and the second tube 18 determined in S4, the sonic conductance of the air cylinder and the inner diameter of the cylinder tube selected in S2, and the like.

In S7, the value calculated in S6 and the required stroke time are compered. If it is determined that the calculated value is greater than the required stroke time, that is, if it is determined that the requirement is not satisfied, the process proceeds to S8. If it is determined that the calculated value is less than or equal to the required stroke time, that is, if it is determined that the requirement is satisfied, the process moves to S9.

In S8, it is determined whether a tube having the maximum inner diameter is selected from the database of tubes. If the selected tube has the maximum inner diameter, the process returns to S2, and an air cylinder is selected again, excluding the air cylinders that have already been selected. Otherwise, the process returns to S3, and a tube having the minimum inner diameter is selected again from the database for selecting tubes, excluding the tubes that have already been selected.

In S9, a speed controller having the minimum sonic conductance among speed controllers having greater sonic conductances than the first tube 16 and the second tube 18 is selected from the database of speed controllers. Moreover, a switching valve having the minimum sonic conductance among switching valves having greater sonic conductances than the first tube 16 and the second tube 18 is selected from the database of switching valves. Furthermore, a silencer having the minimum sonic conductance among silencers having greater sonic conductances than the first tube 16 and the second tube 18 is selected from the database of silencers.

In S10, the stroke time of the air cylinder is calculated by simulation in consideration of the sonic conductances of the speed controller, the switching valve, and the silencer selected in S9.

In S11, the value calculated in S10 and the required stroke time are compered. If it is determined that the calculated value is greater than the required stroke time, the process returns to S9, and from among the previously selected speed controller, switching valve, and silencer, the one having the minimum sonic conductance is selected again. For example, in a case where the sonic conductance of the previous speed controller is less than the sonic conductances of the previous switching valve and silencer, a speed controller having the next greater sonic conductance than the previous speed controller is selected while the same switching valve and silencer as the previous switching valve and silencer are selected.

If it is determined that the calculated value of the stroke time is less than or equal to the required stroke time in S11, the process moves to S12. In S12, it is determined that the inner diameter of the last selected tube is applied to the first tube 16 and the second tube 18 and that the air cylinder, the speed controller, the switching valve, and the silencer that are selected last are adopted. Then, the process ends.

According to the design method of this embodiment, the sonic conductances of the first tube 16 and the second tube 18 are less than the sonic conductances of the cylinder port portions of the air cylinder 12, the first speed controller 38, the second speed controller 40, the switching valve 14, and the silencers 64a and 64b. That is, the reference resistance of the fluid circuit is approximately determined by the tubes. In addition, the fluid circuit can be easily designed since the instruments are selected from the databases.

In the design method of this embodiment, in S9, the speed controller is simply selected from the speed controllers having greater sonic conductances than the tubes. However, the speed controller may be selected from the speed controllers of which sonic conductances are greater than or equal to twice the sonic conductances of the tubes. The same applies to the switching valve and the silencer.

The air cylinder fluid circuit and the method for designing the air cylinder fluid circuit according to the present invention are not limited in particular to the embodiments and the design example described above, and may have various structures without departing from the scope of the present invention as a matter of course.

1. An air cylinder fluid circuit comprising:
a switching valve configured to switch between supply and discharge of compressed air;
an air cylinder; and
a tube connecting the switching valve and a cylinder port portion of the air cylinder, wherein
a sonic conductance of the tube is less than sonic conductances of the switching valve and the cylinder port portion.

2. The air cylinder fluid circuit according to claim 1, wherein the sonic conductance of the tube is less than or equal to half the sonic conductances of the switching valve and the cylinder port portion.

3. The air cylinder fluid circuit according to claim 1, wherein:
a speed controller is disposed between the tube and the cylinder port portion; and
the sonic conductance of the tube is less than a sonic conductance of the speed controller.

4. The air cylinder fluid circuit according to claim 3, wherein the sonic conductance of the tube is less than or equal to half the sonic conductances of the switching valve, the cylinder port portion, and the speed controller.

5. The air cylinder fluid circuit according to claim 4, wherein the sonic conductance of the tube is substantially half the sonic conductance of the speed controller.

6. The air cylinder fluid circuit according to claim 1, wherein:
a silencer is provided to an exhaust port of the switching valve; and
the sonic conductance of the tube is less than a sonic conductance of the silencer.

7. The air cylinder fluid circuit according to claim 6, wherein the sonic conductance of the tube is less than or equal to half the sonic conductances of the switching valve, the cylinder port portion, and the silencer (64a, 64b).

8. A method for designing an air cylinder fluid circuit including a switching valve configured to switch between supply and discharge of compressed air, an air cylinder, and a tube connecting the switching valve and a cylinder port portion of the air cylinder, the method comprising:
selecting a predetermined air cylinder, a predetermined tube, and a predetermined switching valve from a database of air cylinders, a database of tubes, and a database of switching valves, respectively, to design the air cylinder fluid circuit such that a sonic conductance of the tube is less than sonic conductances of the switching valve and the cylinder port portion.

9. The method for designing the air cylinder fluid circuit according to claim 8, wherein:
a speed controller is disposed between the tube and the cylinder port portion in the air cylinder fluid circuit; and
the method further comprises selecting a predetermined speed controller from a database of speed controllers to design the air cylinder fluid circuit such that the sonic conductance of the tube is less than a sonic conductance of the speed controller.

10. The method for designing the air cylinder fluid circuit according to claim 8, wherein:
a silencer is provided to an exhaust port of the switching valve in the air cylinder fluid circuit; and
the method further comprises selecting a predetermined silencer from a database of silencers to design the air cylinder fluid circuit such that the sonic conductance of the tube is less than a sonic conductance of the silencer.
